(19) United States
(12) Patent Application Publication
(10) Pub. No.: US 2024/0332565 A1
(43) Pub. Date: Oct. 3, 2024

(54) ELECTROCHEMICAL CELL

(71) Applicant: NGK INSULATORS, LTD., Nagoya-shi (JP)

(72) Inventors: Genta TERAZAWA, Nagoya-shi (JP); Toshiyuki NAKAMURA, Handa-shi (JP); Takashi SHIRATORI, Nagoya-shi (JP); Makoto OHMORI, Nagoya-shi (JP)

(21) Appl. No.: 18/599,366

(22) Filed: Mar. 8, 2024

Related U.S. Application Data
(63) Continuation of application No. PCT/JP2023/013503, filed on Mar. 31, 2023.

(51) Int. Cl. H01M 8/04119; H01M 8/0206; H01M 8/14

(52) U.S. Cl. CPC H01M 8/04149; H01M 8/0206; H01M 8/141

(57) ABSTRACT

An electrochemical cell includes: a metal substrate having a principal surface and a plurality of connecting holes formed in the principal surface; and a cell body disposed on the principal surface. The cell body has: a gas diffusion layer disposed on the principal surface, the gas diffusion layer being electrically conductive; a first electrode layer disposed on the gas diffusion layer; a second electrode layer; and an electrolyte layer disposed between the first electrode layer and the second electrode layer. The metal substrate has: a gas-permeable region in which the plurality of connecting holes are formed; and a non-gas-permeable region surrounding the gas-permeable region in a plan view. The gas diffusion layer has: a first region formed on the gas-permeable region; and a second region formed on the non-gas-permeable region. The second region has a crack-preventing space in a cross section along a thickness direction.

### CROSS-REFERENCE TO RELATED APPLICATION

This is a continuation of PCT/JP2023/013503, filed on Mar. 31, 2023, the entire contents of which are hereby incorporated by reference.

### TECHNICAL FIELD

The present invention relates to an electrochemical cell.

### BACKGROUND ART

Electrochemical cells (electrolytic cells, fuel cells etc.) are conventionally known that have a cell body disposed on a metal substrate. The metal substrate has a plurality of connecting holes, which are formed in a principal surface thereof. The cell body has a first electrode layer formed on the principal surface of the metal substrate, a second electrode layer, and an electrolyte layer disposed between the first electrode layer and the second electrode layer.

Here, WO 2021/221052 describes interposing an electrically conductive gas diffusion layer between a cell body and a metal substrate.

### SUMMARY

However, in the electrochemical cell described in WO 2021/221052, there is concern that a crack may be caused in the gas diffusion layer by stress that occurs between the metal substrate and the gas diffusion layer due to a difference in thermal expansion coefficient between the metal substrate and the cell body.

An object of the present invention is to provide an electrochemical cell capable of preventing a crack from occurring in the gas diffusion layer.

An electrochemical cell according to a first aspect of the present invention includes: a metal substrate having a principal surface and a plurality of connecting holes formed in the principal surface; and a cell body disposed on the principal surface. The cell body has: a gas diffusion layer disposed on the principal surface, the gas diffusion layer being electrically conductive; a first electrode layer disposed on the gas diffusion layer; a second electrode layer; and an electrolyte layer disposed between the first electrode layer and the second electrode layer. The metal substrate has: a gas-permeable region in which the plurality of connecting holes are formed; and a non-gas-permeable region surrounding the gas-permeable region in a plan view. The gas diffusion layer has: a first region formed on the gas-permeable region; and a second region formed on the non-gas-permeable region. The second region has a crack-preventing space in a cross section along a thickness direction.

An electrochemical cell according to a second aspect of the present invention is the electrochemical cell of the first aspect, wherein in the cross section, the crack-preventing space is located on an opposite side to the first region relative to a center of the second region in a surface direction perpendicular to the thickness direction.

An electrochemical cell according to a third aspect of the present invention is the electrochemical cell of the first or second aspect, wherein in the cross section, a width of the crack-preventing space in a surface direction perpendicular to the thickness direction is 20% or more and 60% or less of a total width of the second region in the surface direction perpendicular to the thickness direction.

An electrochemical cell according to a fourth aspect of the present invention is the electrochemical cell of the third aspect, wherein in the cross section, the crack-preventing space extends in the surface direction perpendicular to the thickness direction.

An electrochemical cell according to a fifth aspect of the present invention is the electrochemical cell of any one of the first to fourth aspects, wherein in the cross section, an inner end face being a portion on the first region side of an inner face of the crack-preventing space protrudes to form a curved shape toward the first region.

An electrochemical cell according to a sixth aspect of the present invention is the electrochemical cell of any one of the first to fifth aspects, wherein the second region has a plurality of the crack-preventing spaces. In a plan view of the second region, the second region has a large-quantity region including a large number of the crack-preventing spaces, and a small-quantity region including a small number of the crack-preventing spaces. The large-quantity region and the small-quantity region are adjacent to each other along an outer edge of the second region.

According to the present invention, it is possible to provide an electrochemical cell capable of preventing a crack from occurring in the gas diffusion layer.

### BRIEF DESCRIPTION OF DRAWINGS

FIG. 1 is a plan view of an electrolytic cell according to an embodiment.

FIG. 2 shows an A-A cross-section of FIG. 1.

FIG. 3 is a partial enlarged view of FIG. 2.

FIG. 4 is a partial enlarged view of FIG. 2.

FIG. 5 is a plan view of the electrolytic cell according to the embodiment from which a hydrogen electrode layer, an electrolyte layer, a reaction-preventing layer, and an oxygen electrode layer are removed.

### DESCRIPTION OF EMBODIMENTS

### Electrolytic Cell 1

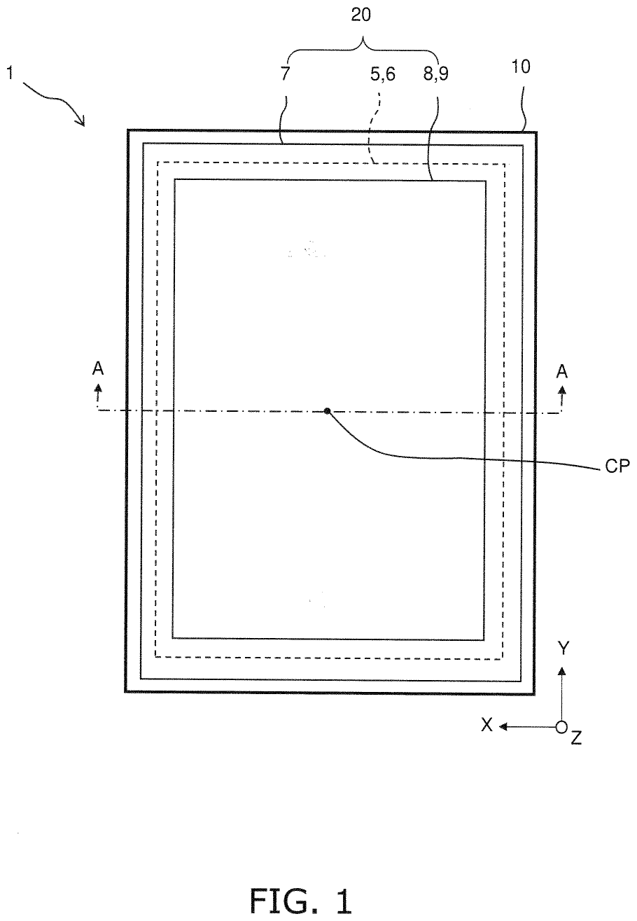

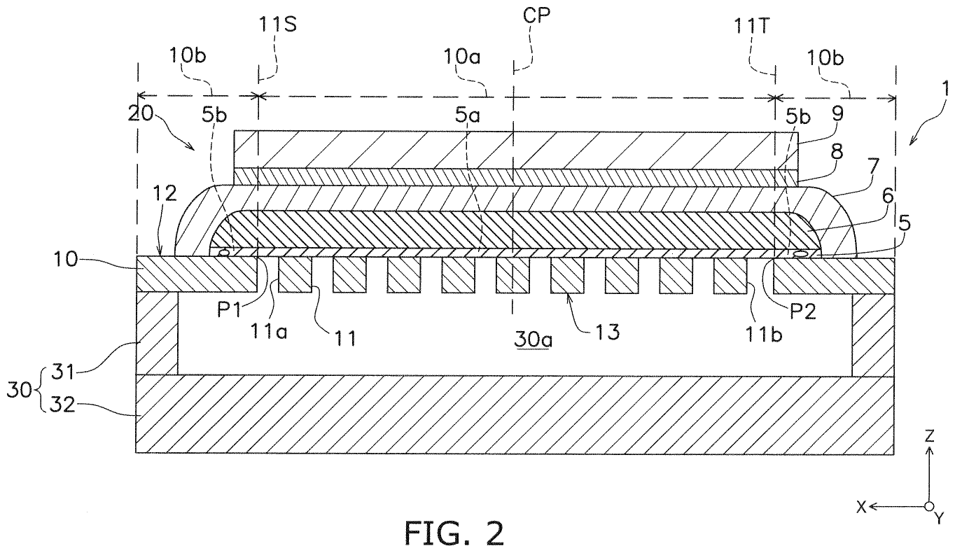

FIG. 1 is a plan view of an electrolytic cell 1 according to an embodiment. FIG. 2 shows an A-A cross-section of FIG. 1. FIG. 2 shows a cross section that passes through a geometric center CP of a metal substrate 10 in a plan view.

The electrolytic cell 1 is an example of an “electrochemical cell” according to the present invention. The electrolytic cell 1 is a so-called metal-supported electrolytic cell.

The electrolytic cell 1 has a plate shape expanding in an X-axis direction and a Y-axis direction. The electrolytic cell 1 in the present embodiment has a rectangular shape elongated in the Y-axis direction in a plan view from a Z-axis direction perpendicular to the X-axis direction and the Y-axis direction. However, the shape of the electrolytic cell 1 in the plan view is not specifically limited, and may alternatively be other than a rectangular shape, and may be a polygonal shape, an elliptic shape, a circular shape, or the like.

As shown in FIG. 2, the electrolytic cell 1 includes a metal substrate 10, a cell body 20, and a channel member 30.

### Metal Substrate 10

The metal substrate 10 supports the cell body 20. The metal substrate 10 has a plate shape. The metal substrate 10 may have a flat plate shape or a curved plate shape.

The metal substrate 10 need only be capable of supporting the cell body 20. The thickness of the metal substrate 10 is not specifically limited, but may be, for example, 0.1 mm or more and 2.0 mm or less.

As shown in FIG. 2, the metal substrate 10 has a plurality of connecting holes 11, a first principal surface 12, and a second principal surface 13.

Each connecting hole 11 extends through the metal substrate 10 from the first principal surface 12 to the second principal surface 13. Each connecting hole 11 is open in the first principal surface 12 and the second principal surface 13. In the present embodiment, the opening of each connecting hole 11 in the first principal surface 12 is covered by a later-described gas diffusion layer 5. The opening of each connecting hole 11 in the second principal surface 13 is continuous with a later-described channel 30a.

The connecting holes 11 can be formed by means of mechanical processing (e.g. punching), laser processing, chemical processing (e.g. etching), or the like.

Each connecting hole 11 in the present embodiment has a straight shape extending along the Z-axis direction. However, each connecting hole 11 may be inclined relative to the Z-axis direction, and need not necessarily has a straight shape. The connecting holes 11 may be continuous with each other.

The first principal surface 12 is an example of a “principal surface” according to the present invention. The first principal surface 12 is provided on the opposite side to the second principal surface 13. The cell body 20 is disposed on the first principal surface 12. The channel member 30 is joined to the second principal surface 13.

As shown in FIG. 2, the metal substrate 10 has a gas-permeable region 10a and a non-gas-permeable region 10b. The gas-permeable region 10a is a region in the metal substrate 10 where a plurality of connecting holes 11 are formed. The non-gas-permeable region 10b is a region in the metal substrate 10 excluding the gas-permeable region 10a. The non-gas-permeable region 10b surrounds the gas-permeable region 10a in a plan view from the Z-axis direction. Thus, in the cross section of the metal substrate 10 along the Z-axis direction, the non-gas-permeable region 10b appears on both sides of the gas-permeable region 10a, as shown in FIG. 2.

The boundary between the gas-permeable region 10a and the non-gas-permeable region 10b is defined by first and second connecting holes 11a and 11b, which are located on the outermost sides in the X-axis direction, as shown in FIG. 2. Specifically, the boundary between the gas-permeable region 10a and the non-gas-permeable region 10b is defined by a first reference line 11S and a second reference line 11T.

The first reference line 11S is a straight line that passes through an outermost position P1, in the X-axis direction, of an opening on the first primary surface 12 side of the first connecting hole 11a located at an outermost position in the X-axis direction, and is parallel to the Z-axis direction (i.e. perpendicular to the first principal surface 12 in FIG. 2).

The second reference line 11T is a straight line that passes through an outermost position P2, in the X-axis direction, of an opening on the first primary surface 12 side of the second connecting hole 11b farthest from the first connecting hole 11a in the X-axis direction, and is parallel to the Z-axis direction (i.e. perpendicular to the first principal surface 12 in FIG. 2).

The gas-permeable region 10a is a region between the first reference line 11S and the second reference line 11T in the metal substrate 10, and the non-gas-permeable region 10b is a region in the metal substrate 10 excluding the gas-permeable region 10a, i.e. a region including portions on both sides of the gas-permeable region 10a.

The metal substrate 10 is made of a metallic material. The metal substrate 10 is, for example, made of an alloy material containing Cr (chromium). Examples of such metallic materials include Fe—Cr alloy steel (stainless steel etc.) and Ni—Cr alloy steel. The content of Cr in the metal substrate 10 is not specifically limited, but can be 4% by mass or more and 30% by mass or less.

The metal substrate 10 may also contain Ti (titanium) and/or Zr (zirconium). The content of Ti in the metal substrate 10 is not specifically limited, but can be 0.01 mol % or more and 1.0 mol % or less. The content of Al in the metal substrate 10 is not specifically limited, but can be 0.01 mol % or more and 0.4 mol % or less. The metal substrate 10 may contain Ti in the form of TiO₂ (titania) and may contain Zr in the form of Zro₂ (zirconia).

The metal substrate 10 may have, on a surface thereof, an oxide film formed by oxidation of constituent elements of the metal substrate 10. A typical oxide film is, for example, a chromium oxide film. The chromium oxide film covers at least a portion of the surface of the metal substrate 10. The chromium oxide film may also cover at least a portion of an inner wall surface of each connecting hole 11.

Cell body 20

The cell body 20 is disposed on the metal substrate 10. The cell body 20 is supported by the metal substrate 10. The cell body 20 has a gas diffusion layer 5, a hydrogen electrode layer 6 (cathode), an electrolyte layer 7, a reaction-preventing layer 8, and an oxygen electrode layer 9 (anode).

The gas diffusion layer 5, the hydrogen electrode layer 6, the electrolyte layer 7, the reaction-preventing layer 8, and the oxygen electrode layer 9 are stacked in this order from the metal substrate 10 side in the Z-axis direction. The gas diffusion layer 5, the hydrogen electrode layer 6, the electrolyte layer 7, and the oxygen electrode layer 9 are essential components, and the reaction-preventing layer 8 is an optional component.

Gas diffusion layer 5

The gas diffusion layer 5 is disposed on the first principal surface 12 of the metal substrate 10. The gas diffusion layer 5 is interposed between the metal substrate 10 and the hydrogen electrode layer 6. The gas diffusion layer 5 in the present embodiment covers the connecting holes 11 in the metal substrate 10. The gas diffusion layer 5 may be partially located within the connecting holes 11 of the metal substrate 10.

The gas diffusion layer 5 is an electrically conductive porous body having gas diffusion properties. The gas diffusion layer 5 supplies a source gas supplied from the connecting holes 11 to the hydrogen electrode layer 6, and discharges a gas produced in the hydrogen electrode layer 6 through the connecting holes 11. The gas diffusion layer 5 has a large number of micropores. The pore diameter of each micropore is not specifically limited, but can be, for example, 0.01 μm or more and 1 μm or less.

The gas diffusion layer 5 contains an electrically conductive material. The electrically conductive material may be a metallic material, such as Ni (nickel) or Fe (iron), or an electrically conductive ceramic material.

The gas diffusion layer 5 may also contain a base material that supports the electrically conductive material. The base material may be insulating. The base material can be YSZ, CSZ, ScSZ, GDC, SDC, (La, Sr) (Cr, Mn) O₃, (La, Sr) TiO₃, Sr₂ (Fe, Mo)₂O₆, (La, Sr) VO₃, (La, Sr) FeO₃, LDC (lanthanum-doped ceria), LSGM (lanthanum gallate), or a mixed material of two or more of these materials.

The gas diffusion layer 5 may contain a metallic element contained in the metal substrate 10. This brings the gas diffusion layer 5 and the metal substrate 10 into more intimate contact and is therefore preferable. Note that the aforementioned electrically conductive material is different from the metallic element contained in the metal substrate 10. Accordingly, the electrically conductive material contained in the gas diffusion layer 5 need not be contained in the metal substrate 10.

The porosity of the gas diffusion layer 5 is not specifically limited, but can be, for example, 20% or more and 40% or less.

The porosity of the gas diffusion layer 5 is calculated by the following method. First, a cross section of the gas diffusion layer 5 along the Z-axis direction is exposed. Next, a backscattered electron image of the cross section of the gas diffusion layer 5 is acquired at a magnification of 10000 times using a SEM device (FE-SEM JSM-7900F, manufactured by JEOL Ltd.). Next, portions displayed in black (which correspond to pores) in the backscattered electron image are identified using image analysis software Image-Pro, manufactured by MEDIACYBERNETICS. Then, the porosity of the gas diffusion layer 5 is calculated by dividing the total area of the pores by the total area of the backscattered electron image of the gas diffusion layer 5.

The thickness of the gas diffusion layer 5 is not specifically limited, but can be, for example, 1 μm or more and 50 μm or less. The term “thickness” as used herein means the thickness in the thickness direction of the cell body 20. The term “thickness direction” refers to a direction perpendicular to a surface direction parallel to the first principal surface 12 of the metal substrate 10. The thickness direction is identified by using an approximate straight line of the first principal surface 12 that is obtained by the least squares method in a cross section of the metal substrate 10 along the Z-axis direction.

As shown in FIG. 2, the gas diffusion layer 5 has a first region 5a and a second region 5b. The first region 5a is a region in the gas diffusion layer 5 that is formed on the gas-permeable region 10a of the metal substrate 10. The second region 5b is a region in the gas diffusion layer 5 that is formed on the non-gas-permeable region 10b of the metal substrate 10. The second region 5b surrounds the first region 5a in a plan view from the Z-axis direction. Thus, in the cross section of the gas diffusion layer 5 along the Z-axis direction, the second region 5b appears on both sides of the first region 5a, as shown in FIG. 2.

The boundary between the first region 5a and the second region 5b is defined by the aforementioned first reference line 11S and second reference line 11T. The first region 5a is a region between the first reference line 11S and the second reference line 11T in the gas diffusion layer 5, and the second region 5b is a region in the metal substrate 5 excluding the first region 5a, i.e. a region including portions on both sides of the first region 5a.

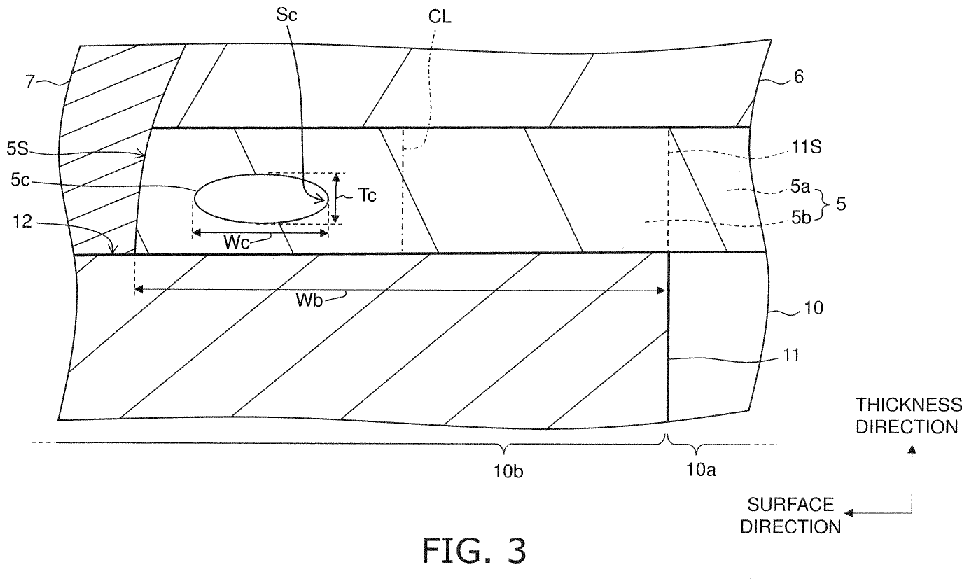

Here, FIG. 3 is a partial enlarged view of FIG. 2. FIG. 3 shows a cross section of the second region 5b that passes through a geometric center CP of the metal substrate 10 and is taken along the thickness direction of the cell body 20.

As shown in FIG. 3, the second region 5b has a crack-preventing space 5c. The crack-preventing space 5c is a void within the second region 5b. A crack can be prevented from occurring in the gas diffusion layer 5 by providing this crack-preventing space 5c in the second region 5b, in the following manner. First, stress occurs in the surface direction between the metal substrate 10 and the gas diffusion layer 5 due to a difference in thermal expansion coefficient between the metal substrate 10 and the cell body 20. This stress may cause a crack starting from the vicinity of an outer end face 5S of the gas diffusion layer 5 and extending inward (i.e. toward the first region 5a). However, when the crack reaches the crack-preventing space 5c, the stress that caused the crack can be absorbed by the crack-preventing space 5c, and it is therefore possible to prevent the crack from growing beyond the crack-preventing space 5c.

It is preferable that the crack-preventing space 5c is located on the opposite side to the first region 5a relative to a center CL of the second region 5b in the surface direction, as shown in FIG. 3. That is, it is preferable that the crack-preventing space 5c is close to an outer edge of the second region 5b. This can quickly stop the growth of the crack starting from the vicinity of the outer end face 5S of the gas diffusion layer 5. Thus, even if a crack occurs, the crack can be prevented from lengthening.

It is preferable that a width Wc of the crack-preventing space 5c in the surface direction is 20% or more and 60% or less of a total width Wb of the second region 5b in the surface direction. The width Wc of the crack-preventing space 5c being 20% or more of the total width Wb of the second region 5b allows the crack-preventing space 5c to reliably absorb the stress that caused a crack. The width Wc of the crack-preventing space 5c being 60% or less of the total width Wb of the second region 5b can ensure the strength of the second region 5b.

Note that the value of the width Wc of the crack-preventing space 5c is not specifically limited, but can be, for example, 5 μm or more and 500 μm or less. The value of the width Wb of the second region 5b is not specifically limited, but can be, for example, 20 μm or more and 2000 μm or less. The equivalent circle diameter of the crack-preventing space 5c is not specifically limited, but can be, for example, 5 μm or more and 500 μm or less. The equivalent circle diameter is the diameter of a circle that has the same area as the crack-preventing space 5c in a cross section of the second region 5b.

It is preferable that the crack-preventing space 5c is elongated in the surface direction, as shown in FIG. 3. That is, it is preferable that the width Wc of the crack-preventing space 5c in the surface direction is larger than a height Tc of the crack-preventing space 5c in the thickness direction. This makes it easier for the crack-preventing space 5c to absorb the stress occurring in the surface direction between the metal substrate 10 and the gas diffusion layer 5. It is therefore possible to prevent the crack from growing beyond the crack-preventing space 5c.

Note that the value of the height Tc of the crack-preventing space 5c is not specifically limited, but can be, for example, 1 μm or more and 50 μm or less.

It is preferable that an inner end face Sc, which is a portion on the first region 5a side of the inner face of the crack-preventing space 5c, protrudes to form a curved shape toward the first region 5a, as shown in FIG. 3. This makes it easier to absorb, with the inner end face Sc, the stress occurring in the surface direction between the metal substrate 10 and the gas diffusion layer 5, compared to the case where the inner end face Sc has a straight shape. It is therefore possible to prevent the crack from growing beyond the crack-preventing space 5c.

It is preferable that the crack-preventing space 5c is separated from the outer end face 5S of the gas diffusion layer 5, as shown in FIG. 3. That is, it is preferable that the crack-preventing space 5c is not exposed from the outer end face 5S. This can ensure the strength of the gas diffusion layer 5.

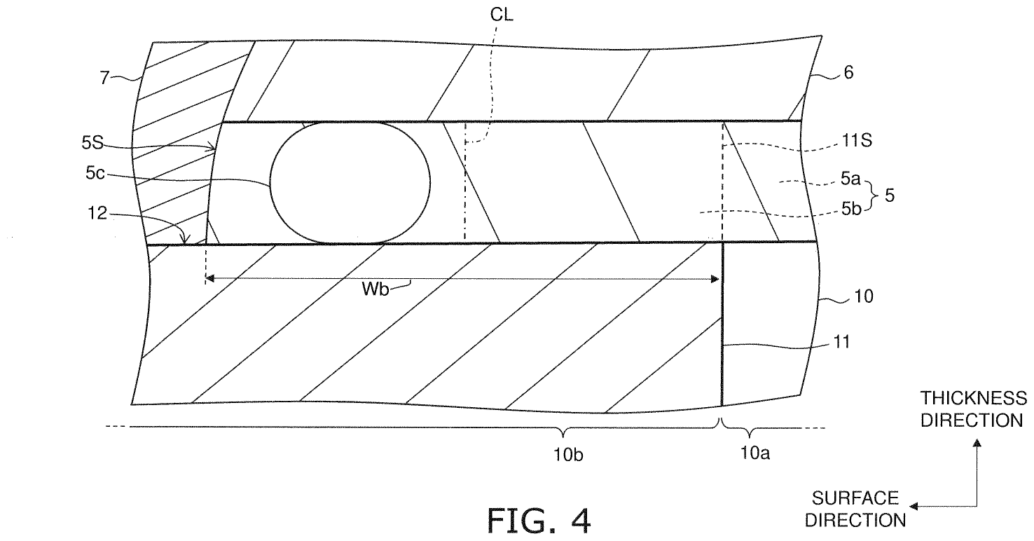

The crack-preventing space 5c in the present embodiment is separated from the hydrogen electrode layer 6 and the metal substrate 10, as shown in FIG. 3, but may alternatively be in contact with at least either the hydrogen electrode layer 6 or the metal substrate 10. For example, the crack-preventing space 5c may be in contact with the hydrogen electrode layer 6 and the metal substrate 10, as shown in FIG. 4. That is, the crack-preventing space 5c may extend through the gas diffusion layer 5 in the thickness direction. In this case, it is possible to reliably prevent a crack from growing across gaps between the hydrogen electrode layer 6 and the crack-preventing space 5c and between the metal substrate 10 and the crack-preventing space 5c.

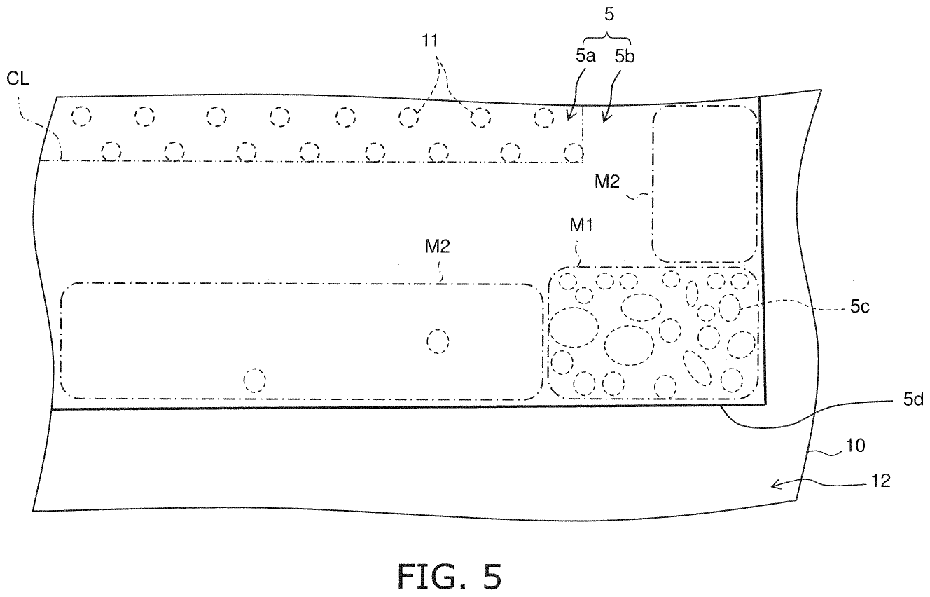

Here, FIG. 5 is an enlarged plan view of the electrolytic cell 1 in which the hydrogen electrode layer 6, the electrolyte layer 7, the reaction-preventing layer 8, and the oxygen electrode layer 9 are removed from the cell body 20.

In a plan view of the second region 5b, the second region 5b includes a plurality of crack-preventing spaces 5c, as shown in FIG. 5.

The second region 5b may include a large-quantity region M1 and a small-quantity region M2, as shown in FIG. 5. The large-quantity region M1 and the small-quantity region M2 are adjacent to each other along an outer edge 5d of the second region 5b.

The large-quantity region M1 is a region in the second region 5b that includes a large number of crack-preventing spaces 5c. The small-quantity region M2 is a region in the second region 5b that includes a small number of crack-preventing spaces 5c.

As used herein, “including a large number of crack-preventing spaces 5c” means that 10 or more crack-preventing spaces 5c are present per unit area (1 cm2). “Including a small number of crack-preventing spaces 5c” means that less than 10 crack-preventing spaces 5c are present per unit area (1 cm2), or no crack-preventing space 5c is present.

A crack can be prevented from occurring in the second region 5b by providing the large-quantity region M1 at portions of the second region 5b where particularly large stress occurs (specifically, corners). Further, the strength of the second region 5b can be ensured by providing the small-quantity region M2 at portions other than the large-quantity region M1. It is therefore possible to both prevent a crack and ensure the strength by appropriately arranging the large-quantity region M1 and the small-quantity region M2.

The number, position, and size of the large-quantity region M1 and the small-quantity region M2 can be set as appropriate.

The method of forming the gas diffusion layer 5 is not specifically limited, and can be a sintering method, a spray coating method, a PVD method, a CVD method, or the like. For example, in the case of forming the gas diffusion layer 5 by means of the sintering method, a compact of the gas diffusion layer 5 can be formed by applying a slurry containing the constituent material of the gas diffusion layer 5 onto the gas-permeable region 10a of the metal substrate 10, and thereafter applying a slurry containing a pore former and the constituent material of the gas diffusion layer 5 onto the gas-permeable region 10a of the metal substrate 10. The crack-preventing space 5c is formed in the second region 5b as a result of the pore former disappearing in the process of sintering the compact of the gas diffusion layer 5.

In the case of providing the large-quantity region M1 and the small-quantity region M2 in the second region 5b, it is possible that a slurry containing a large amount of pore former and a slurry containing a small amount of pore former (or a slurry containing no pore former) are prepared, and each type of slurry is applied separately onto the gas-permeable region 10a of the metal substrate 10.

### Hydrogen Electrode Layer 6

The hydrogen electrode layer 6 is an example of a “first electrode layer” according to the present invention. The hydrogen electrode layer 6 is formed on the gas diffusion layer 5. The hydrogen electrode layer 6 is disposed between the gas diffusion layer 5 and the electrolyte layer 7.

The source gas is supplied to the hydrogen electrode layer 6 from the connecting holes 11 via the gas diffusion layer 5. The source gas contains at least H₂O.

When the source gas contains only H₂O, the hydrogen electrode layer 6 produces H₂ from the source gas in accordance with the electrochemical reaction of water electrolysis expressed by the following chemical equation (1).

Hydrogen electrode layer 6: H₂O+2e⁻→H₂+O²⁻ (1)

When the source gas contains CO₂ in addition to H₂O, the hydrogen electrode layer 6 produces H₂, CO, and O²⁻ from the source gas in accordance with the electrochemical reaction of co-electrolysis expressed by the following chemical equations (2), (3), and (4).

Hydrogen electrode layer 6: CO₂+H₂O+4e⁻→CO+H₂+2O²⁻ (2)

Electrochemical reaction of H₂O: H₂O+2e⁻→H₂+O²⁻ (3)

Electrochemical reaction of CO₂: CO₂+2e⁻→CO+O²⁻ (4)

The hydrogen electrode layer 6 is an electrically conductive porous body having gas diffusion properties. The source gas is supplied to the hydrogen electrode layer 6 from the gas diffusion layer 5. A gas produced in the hydrogen electrode layer 6 is discharged toward the gas diffusion layer 5.

The hydrogen electrode layer 6 contains an electrically conductive material. The electrically conductive material may be a metallic material, such as Ni (nickel) or Fe (iron), or an electrically conductive ceramic material. In the case of co-electrolysis, Ni also functions as a thermal catalyst to promote the thermal reaction between H₂ produced and CO₂ contained in the source gas and maintain a gas composition appropriate for methanation, reverse water-gas shift reactions, or the like.

The electrically conductive material exists in an oxide state (e.g. NiO) in an oxidizing atmosphere, and exists in a metallic state (e.g. Ni) in a reducing atmosphere. The present embodiment envisions that the electrolytic cell 1 is exposed to a reducing atmosphere.

The hydrogen electrode layer 6 contains an oxide ion-conductive material. The oxide ion-conductive material can be YSZ, CSZ, ScSZ, GDC, SDC, (La, Sr) (Cr, Mn) O₃, (La, Sr) TiO₃, Sr₂ (Fe, Mo)₂O₆, (La, Sr) VO₃, (La, Sr) FeO₃, LDC, LSGM, or a mixed material of two or more of these materials.

In the present embodiment, the hydrogen electrode layer 6 has a single layer structure constituted by a single composition, but may alternatively have a multilayer structure constituted by different compositions.

The porosity of the hydrogen electrode layer 6 is not specifically limited, but can be, for example, 20% or more and 40% or less. The porosity of the hydrogen electrode layer 6 is calculated by dividing the total area of pores by the total area of the backscattered electron image of the hydrogen electrode layer 6, similarly to the aforementioned porosity of the gas diffusion layer 5.

The thickness of the hydrogen electrode layer 6 is not specifically limited, but can be, for example, 1 μm or more and 500 μm or less.

The method of forming the hydrogen electrode layer 6 is not specifically limited, and can be a sintering method, a spray coating method, a PVD method, a CVD method, or the like.

### Electrolyte Layer 7

The electrolyte layer 7 is disposed between the hydrogen electrode layer 6 and the oxygen electrode layer 9. In the present embodiment, the reaction-preventing layer 8 is disposed between the electrolyte layer 7 and the oxygen electrode layer 9, and the electrolyte layer 7 is therefore sandwiched between the hydrogen electrode layer 6 and the reaction-preventing layer 8.

The electrolyte layer 7 covers the hydrogen electrode layer 6 and also covers a region of the first principal surface 12 of the metal substrate 10 that is exposed from the gas diffusion layer 5.

The electrolyte layer 7 transmits O²⁻ produced in the hydrogen electrode layer 6 toward the oxygen electrode layer 9. The electrolyte layer 7 is made of an oxide ion-conductive dense material. The electrolyte layer 7 can be made of, for example, YSZ (yttria stabilized zirconia; e.g. 8YSZ), GDC (gadolinium doped ceria), ScSZ (scandia stabilized zirconia), SDC (samarium solid solution ceria), LSGM (lanthanum gallate), or the like. The porosity of the electrolyte layer 7 is not

specifically limited, but can be, for example, 0.1% or more and 7% or less. The thickness of the electrolyte layer 7 is not specifically limited, but can be, for example, 1 μm or more and 100 μm or less.

The method of forming the electrolyte layer 7 is not specifically limited, and can be a sintering method, a spray coating method, a PVD method, a CVD method, or the like.

### Reaction-Preventing Layer 8

The reaction-preventing layer 8 is disposed between the electrolyte layer 7 and the oxygen electrode layer 9. The reaction-preventing layer 8 is disposed on the opposite side to the hydrogen electrode layer 6 with respect to the electrolyte layer 7. The reaction-preventing layer 8 prevents a constituent element of the electrolyte layer 7 from reacting with a constituent element of the oxygen electrode layer 9 to form a layer with high electrical resistance.

The reaction-preventing layer 8 is constituted by an oxide ion-conductive material. The reaction-preventing layer 8 can be made of GDC, SDC, or the like.

The porosity of the reaction-preventing layer 8 is not specifically limited, but can be, for example, 0.1% or more and 50% or less. The thickness of the reaction-preventing layer 8 is not specifically limited, but can be, for example, 1 μm or more and 50 μm or less.

The method of forming the reaction-preventing layer 8 is not specifically limited, and can be a sintering method, a spray coating method, a PVD method, a CVD method, or the like.

### Oxygen Electrode Layer 9

The oxygen electrode layer 9 is an example of a “second electrode layer” according to the present invention. The oxygen electrode layer 9 is disposed on the opposite side to the hydrogen electrode layer 6 with respect to the electrolyte layer 7. In the present embodiment, the reaction-preventing layer 8 is disposed between the electrolyte layer 7 and the oxygen electrode layer 9, and the oxygen electrode layer 9 is therefore connected to the reaction-preventing layer 8. If the reaction-preventing layer 8 is not disposed between the electrolyte layer 7 and the oxygen electrode layer 9, the oxygen electrode layer 9 is connected to the electrolyte layer 7.

The oxygen electrode layer 9 produces O₂ from O²⁻ transmitted from the hydrogen electrode layer 6 via the electrolyte layer 7, in accordance with the chemical reaction expressed by the following chemical equation (5).

Oxygen electrode layer 9: 2O²⁻→O₂+4e⁻ (5)

The oxygen electrode layer 9 is an oxide ion-conductive and electrically conductive porous body. The oxygen electrode layer 9 can be made of, for example, a composite material of an oxide ion-conductive material (GDC etc.) and at least one of (La, Sr) (Co, Fe)O₃, (La, Sr) FeO₃, La (Ni, Fe)O₃, (La, Sr) CoO₃, and (Sm, Sr) COO₃.

The porosity of the oxygen electrode layer 9 is not specifically limited, but can be, for example, 20% or more and 60% or less. The thickness of the oxygen electrode layer 9 is not specifically limited, but can be, for example, 1 μm or more and 100 μm or less.

The method of forming the oxygen electrode layer 9 is not specifically limited, and can be a sintering method, a spray coating method, a PVD method, a CVD method, or the like.

### Channel Member 30

The channel member 30 is joined to the second principal surface 13 of the metal substrate 10. The channel member 30 forms a channel 30a between the channel member 30 and the metal substrate 10. The source gas is supplied to the channel 30a. The source gas supplied to the channel 30a is supplied to the hydrogen electrode layer 6 of the cell body 20 via the connecting holes 11 in the metal substrate 10.

The channel member 30 can be made of an alloy material, for example. The channel member 30 may be made of the same material as the metal substrate 10. In this case, the channel member 30 may be substantially integrated with the metal substrate 10.

The channel member 30 has a frame 31 and an interconnector 32. The frame 31 is an annular member that surrounds the sides of the channel 30a. The frame 31 is joined to the second principal surface 13 of the metal substrate 10. The interconnector 32 is a plate-shaped member for electrically connecting an external power source or another electrolytic cell to the electrolytic cell 1 in series. The interconnector 32 is joined to the frame 31.

The frame 31 and interconnector 32 in the present embodiment are separate members, but the frame 31 and interconnector 32 may alternatively be an integrated member.

### Variations of Embodiment

Although the embodiment of the present invention has been described above, the present invention is not limited thereto, and various changes can be made without departing from the gist of the invention.

### Variation 1

The crack-preventing space 5c in the above embodiment is located on the opposite side to the first region 5a relative to the center CL of the second region 5b in the surface direction, as shown in FIG. 3. However, this need not be the case. At least a portion of the crack-preventing space 5c may be located on the first region 5a side relative to the center CL of the second region 5b in the surface direction.

### Variation 2

The crack-preventing space 5c in the above embodiment extends in the surface direction, as shown in FIG. 3. However, this need not be the case. The crack-preventing space 5c may alternatively extend in the thickness direction. That is, the width Wc of the crack-preventing space 5c in the surface direction may be smaller than the height Tc of the crack-preventing space 5c in the thickness direction.

### Variation 3

The inner end face Sc of the crack-preventing space 5c in the above embodiment protrudes to form a curved shape toward the first region 5a, as shown in FIG. 3. However, this need not be the case. At least a portion of the inner end face Sc of the crack-preventing space 5c may alternatively be straight.

### Variation 4

The second region 5b in the above embodiment includes the large-quantity region M1 and the small-quantity region M2, as shown in FIG. 5. However, this need not be the case. In the case of the second region 5b having a plurality of crack-preventing spaces 5c, the crack-preventing spaces 5c may be uniformly arranged in a plan view of the second region 5b.

### Variation 5

In the present embodiment, the opening of each connecting hole 11 in the metal substrate 10 on the first principal surface 12 side is covered by the gas diffusion layer 5. However, this need not be the case. The gas diffusion layer 5 need not cover the opening of each connecting hole 11 on the first principal surface 12 side. In this case, the gas diffusion layer 5 has through holes connected to the respective connecting holes 11, and the gas can thus be more efficiently supplied and discharged through these through holes.

### Variation 6

In the above embodiment, the electrolytic cell 1 has been described as an example of an electrochemical cell. However, the electrochemical cell is not limited to an electrolytic cell. The term “electrochemical cell” is a general term for elements in which a pair of electrodes are disposed such that electromotive force is generated from the overall redox reaction in order to convert electrical energy to chemical energy, and elements for converting chemical energy into electrical energy. Accordingly, electrochemical cells include, for example, fuel cells that use oxide ions or protons as carriers.

### REFERENCE SIGNS LIST

1 Electrolytic cell
10 Metal substrate
11 Connecting hole
12 First principal surface
13 Second principal surface
20 Cell body
5 Gas diffusion layer
5S Outer end face of gas diffusion layer
5a First region
5b Second region
5c Crack-preventing space
Sc Inner end face of crack-preventing space
M1 Large-quantity region
M2 Small-quantity region
6 Hydrogen electrode layer
7 Electrolyte layer
8 Reaction-preventing layer
9 Oxygen electrode layer
30 Channel member
30a Channel

1. An electrochemical cell comprising:
a metal substrate having a principal surface and a plurality of connecting holes formed in the principal surface; and
a cell body disposed on the principal surface,
the cell body having:
a gas diffusion layer disposed on the principal surface, the gas diffusion layer being electrically conductive;
a first electrode layer disposed on the gas diffusion layer;
a second electrode layer; and
an electrolyte layer disposed between the first electrode layer and the second electrode layer, wherein
the metal substrate has a gas-permeable region in which the plurality of connecting holes are formed and a non-gas-permeable region surrounding the gas-permeable region in a plan view,
the gas diffusion layer has a first region formed on the gas-permeable region and a second region formed on the non-gas-permeable region, and
the second region has a crack-preventing space in a cross section along a thickness direction.

2. The electrochemical cell according to claim 1, wherein
in the cross section, the crack-preventing space is located on an opposite side to the first region relative to a center of the second region in a surface direction perpendicular to the thickness direction.

3. The electrochemical cell according to claim 1, wherein
in the cross section, a width of the crack-preventing space in a surface direction perpendicular to the thickness direction is 20% or more and 60% or less of a total width of the second region in the surface direction perpendicular to the thickness direction.

4. The electrochemical cell according to claim 3, wherein
in the cross section, the crack-preventing space extends in the surface direction perpendicular to the thickness direction.

5. The electrochemical cell according to claim 1, wherein
in the cross section, an inner end face being a portion on the first region side of an inner face of the crack-preventing space protrudes to form a curved shape toward the first region.

6. The electrochemical cell according to claim 1, wherein
the second region has a plurality of the crack-preventing spaces,
in a plan view of the second region, the second region has a large-quantity region including a large number of the crack-preventing spaces, and a small-quantity region including a small number of the crack-preventing spaces, and
the large-quantity region and the small-quantity region are adjacent to each other along an outer edge of the second region.
